(19) United States
(12) Patent Application Publication
(10) Pub. No.: US 2017/0047009 A1
(43) Pub. Date: Feb. 16, 2017

(54) EMISSION DRIVER AND RELATED ORGANIC LIGHT EMITTING DISPLAY DEVICE

(71) Applicant: Samsung Display Co., Ltd., Yongin-si (KR)

(72) Inventors: Seung Kyu LEE, Yongin-si (KR); Kyoung Jin PARK, Yongin-si (KR); Hyun Ae PARK, Yongin-si (KR); Min Woo BYUN, Yongin-si (KR)

(21) Appl. No.: 15/091,278

(22) Filed: Apr. 5, 2016

(30) Foreign Application Priority Data
Aug. 10, 2015 (KR) 10-2015-0112600

(51) Int. Cl. G09G 3/3258; G09G 3/3275; G09G 3/3266

(52) U.S. Cl. CPC G09G 3/3258; G09G 3/3266; G09G 3/3275; G09G 2300/0426; G09G 2310/08

(57) ABSTRACT

A driver includes a first stage, a second stage, and a third stage. The first stage includes a first input terminal and a second input terminal. The first input terminal is electrically connected to a first clock line, which may transmit a first clock signal. The second input terminal is electrically connected to a second clock line, which may transmit a second clock signal. The second stage includes a third input terminal and a fourth input terminal. The third input terminal is electrically connected through the second input terminal to the second clock line. The fourth input terminal is electrically connected to the first clock line. The third stage includes a fifth input terminal and a sixth input terminal. The fifth input terminal is electrically connected through the fourth input terminal to the first clock line. The sixth input terminal is electrically connected to the second clock line.

### CROSS-REFERENCE TO RELATED APPLICATION

This application claims priority to and the benefit of Korean Patent Application No. 10-2015-0112600, filed on Aug. 10, 2015, in the Korean Intellectual Property Office; the entire contents of the Korean Patent Application are incorporated herein by reference in their entirety.

### BACKGROUND

1. Field

The technical field relates to an emission driver and an organic light emitting display device including the emission driver.

2. Description of the Related Art

An organic light emitting display device may display an image using organic light emitting diodes (OLED) that generate light components through recombination of electrons and holes. An organic light emitting display device may have a high response speed and may be driven with low power consumption.

An organic light emitting display device may include a data driver for supplying data signals to data lines, a scan driver for sequentially supplying scan signals to scan lines, an emission driver for supplying emission control signals to emission control lines, and a pixel unit including a plurality of pixels connected to the data lines, the scan lines, and the emission control lines.

The pixels included in the pixel unit are selected when the scan signals are supplied to the corresponding scan lines. The selected pixels receive data signals to generate light components with brightness components corresponding to the data signals for displaying an image. Here, emission times of the pixels are controlled by emission control signals supplied from the emission driver through the emission control lines.

### SUMMARY

An embodiment may be related to a driver for use in controlling a display device. The driver may include a first stage, a second stage, and a third stage. The first stage may include a first clock-input terminal and a second clock-input terminal. The first clock-input terminal may be electrically connected to a first main clock signal line. The second clock-input terminal may be electrically connected to a second main clock signal line. The first main clock signal line may transmit a first clock signal. The second main clock signal line may transmit a second clock signal.

The second stage may include a third clock-input terminal and a fourth clock-input terminal. The third clock-input terminal may be electrically connected through the second clock-input terminal (and not through any transistor) to the second main clock signal line. The fourth clock-input terminal may be electrically connected to the first main clock signal line.

The third stage may include a fifth clock-input terminal and a sixth clock-input terminal. The fifth clock-input terminal may be electrically connected through the fourth clock-input terminal (and not through any transistor) to the first main clock signal line. The sixth clock-input terminal may be electrically connected to the second main clock signal line.

The driver may include the first main clock signal line and the second main clock signal line.

The driver may include a first interconnect clock signal line. A first end of the first interconnect clock signal line may be electrically (and directly) connected, through no transistor, to the fourth clock-input terminal. A second end of the first interconnect clock signal line may be electrically (and directly) connected, through no transistor, to the fifth clock-input terminal.

The driver may include a capacitor. The capacitor may be electrically connected through the fourth clock-input terminal (and not through any transistor) to the first interconnect clock signal line.

The driver may include a first branch clock signal line. A first end of the first branch clock signal line may be electrically (and directly) connected, through no transistor, to the first main clock signal line. A second end of the first branch clock signal line may be electrically (and directly) connected, through no transistor, to the fourth clock-input terminal. The first branch clock signal line may be electrically connected through the fourth clock-input terminal (and not through any transistor) to the first interconnect clock signal line. The driver may include a second branch clock signal line. A first end of the second branch clock signal line may be electrically (and directly) connected, through no transistor, to the first main clock signal line. A second end of the second branch clock signal line may be electrically (and directly) connected, through no transistor, to the fifth clock-input terminal. The second branch clock signal line may be electrically connected through the fifth clock-input terminal (and not through any transistor) to the first interconnect clock signal line.

The driver may include a branch clock signal line. A first end of the branch clock signal line may be electrically (and directly) connected, through no transistor, to the first main clock signal line. A second end of the branch clock signal line may be electrically (and directly) connected, through no transistor, to the fifth clock-input terminal. The branch clock signal line may be electrically connected through the fifth clock-input terminal (and not through any transistor) to the first interconnect clock signal line.

The driver may include a second interconnect clock signal line. A first end of the second interconnect clock signal line may be electrically (and directly) connected, through no transistor, to the second clock-input terminal. A second end of the second interconnect clock signal line may be electrically (and directly) connected, through no transistor, to the third clock-input terminal. The driver may include a capacitor. The capacitor may be electrically connected through the second clock-input terminal (and not through any transistor) to the second interconnect clock signal line.

The driver may include a branch clock signal line. A first end of the branch clock signal line may be electrically (and directly) connected, through no transistor, to the second main clock signal line. A second end of the branch clock signal line may be electrically (and directly) connected, through no transistor, to the second clock-input terminal. The branch clock signal line may be electrically connected through the second clock-input terminal (and not through any transistor) to the second interconnect clock signal line.

In an emission driver including a plurality of stages according to an embodiment, each of the stages includes the following elements a first transistor connected between an output terminal, which is configured for outputting an emission control signal, and a first power source and having a gate electrode connected to a first node; a second transistor connected between the output terminal and a second power source and having a gate electrode connected to a second node; a third transistor connected between the second power source and the second node and having a gate electrode connected to the first node; a fourth transistor connected between a start terminal, which is configured for receiving a start signal or an emission control signal of a previous stage, and the first node and having a gate electrode connected to a first input terminal; and a first capacitor connected between a second input terminal and the first node. First input terminals of odd stages excluding a first stage are connected to first sub-clock signal lines, which are connected to second input terminals of previous stages. Second input terminals of the odd stages excluding the first stage are connected to a second main clock signal line and second sub-clock signal lines, the second sub-clock signal lines being connected to first input terminals of next stages. First input terminals of even stages are connected to second sub-clock signal lines, which are connected to second input terminals of previous stages. Second input terminals of the even stages are connected to a first main clock signal line and first sub-clock signal lines, the first sub-clock signal lines being connected to first input terminals of next stages. The term “first” may mean “first-type”; the term “second” may mean “second-type”.

The first main clock signal line and the first sub-clock signal lines transmit a first clock signal and the second main clock signal line, and the second sub-clock signal lines transmit a second clock signal. A high voltage and a low voltage are alternately and repeatedly applied to the first clock signal and the second clock signal.

The first sub-clock signal lines are connected to the second input terminals of the even stages and the first input terminals of the odd stages, and the second sub-clock signal lines are connected to the second input terminals of the odd stages and the first input terminals of the even stages. A start terminal of the first stage receives the start signal, and start terminals of stages excluding the first stage receive emission control signals of previous stages.

A first input terminal of the first stage receives a copy of the first clock signal through the first main clock signal line. First input terminals of odd stages excluding the first stage receive copies of the first clock signal through the first sub-clock signal lines. Second input terminals of the odd stages receive copies of the second clock signal through the second main clock signal lines.

First input terminals of the even stages receive copies of the second clock signal through the second sub-clock signal lines, and second input terminals of the even stages receive copies of the first clock signal through the first main clock signal line.

The emission driver further includes the following elements: a fifth transistor connected between the first node and an eighth transistor and having a gate electrode connected to a second input terminal, a sixth transistor connected between the first input terminal and a third node and having a gate electrode connected to the first node, a seventh transistor connected between the first power source and the third node and having a gate electrode connected to the first input terminal, a ninth transistor connected between the second input terminal and a tenth transistor and having a gate electrode connected to the third node, a tenth transistor connected between the ninth transistor and the second node and having a gate electrode connected to the second input terminal, and a second capacitor connected between the tenth transistor and the third node. Wherein the eighth transistor is connected between the second power source and the fifth transistor and having a gate electrode connected to the third node.

The second capacitor is connected between the gate electrode of the ninth transistor and a first electrode of the ninth transistor. The emission driver further includes a third capacitor connected between the second power source and the second node.

An organic light emitting display device according to an embodiment of includes the following elements: a pixel unit including pixels connected to scan lines, data lines, and emission control lines; a scan driver configured to supply scan signals to the pixels through the scan lines; a data driver configured to supply data signals to the pixels through the data lines; and an emission driver including a plurality of stages respectively connected to the emission control lines and configured to supply emission control signals to the pixels through the emission control lines. Each of the stages includes a first transistor connected between an output terminal outputting an emission control signal and a first power source and having a gate electrode connected to a first node, a second transistor connected between the output terminal and a second power source and having a gate electrode connected to a second node, a third transistor connected between the second power source and the second node and having a gate electrode connected to the first node, a fourth transistor connected between a start terminal receiving a start signal or an emission control signal of a previous stage and the first node and having a gate electrode connected to a first input terminal, and a first capacitor connected between a second input terminal and the first node. First input terminals of odd stages excluding a first stage are connected to first sub-clock signal lines connected to second input terminals of previous stages and second input terminals thereof are connected to a second main clock signal line and second sub-clock signal lines connected to first input terminals of next stages. First input terminals of even stages are connected to second sub-clock signal lines connected to second input terminals of previous stages and second input terminals thereof are connected to a first main clock signal line and first sub-clock signal lines connected to first input terminals of next stages.

### BRIEF DESCRIPTION OF THE DRAWINGS

FIG. 1 is a schematic block diagram of an organic light emitting display device according to an embodiment.

FIG. 2 is a schematic block diagram of the emission driver of the organic light emitting display device illustrated in FIG. 1.

FIG. 3 is a circuit diagram of the stages of the emission driver illustrated in FIG. 2.

FIG. 4 is a waveform diagram illustrating an operation of the first stage of FIG. 3.

### DETAILED DESCRIPTION

Embodiments are described in detail with reference to the accompanying drawings.

Although the terms “first”, “second”, etc. may be used herein to describe various elements, these elements should not be limited by these terms. These terms may be used to distinguish one element from another element. Thus, a first element recited in this application may be termed a second element without departing from embodiments. The description of an element as a “first” element may not require or imply the presence of a second element or other elements. The terms “first”, “second”, etc. may also be used herein to differentiate different categories or sets of elements. For conciseness, the terms “first”, “second”, etc. may represent “first-category (or first-set)”, “second-category (or second-set)”, etc., respectively.

If a first element (such as a layer, film, region, or substrate) is referred to as being “on”, “neighboring”, “connected to”, or “coupled with” a second element, then the first element can be directly on, directly neighboring, directly connected to, or directly coupled with the second element, or an intervening element may also be present between the first element and the second element. If a first element is referred to as being “directly on”, “directly neighboring”, “directly connected to”, or “directed coupled with” a second element, then no intended intervening element (except environmental elements such as air) may be provided between the first element and the second element.

The term “connect” may mean “electrically connect”. The term “insulate” may mean “electrically insulate”. The term “conductive” may mean “electrically conductive”. The term “electrically connected” may mean “electrically connected without any intervening transistors” or “electrically connected through no intervening transistors”. The term “connected between a first element and a second element” may mean “having a first terminal that is connected to the first element and having a second terminal that is connected to the second element”.

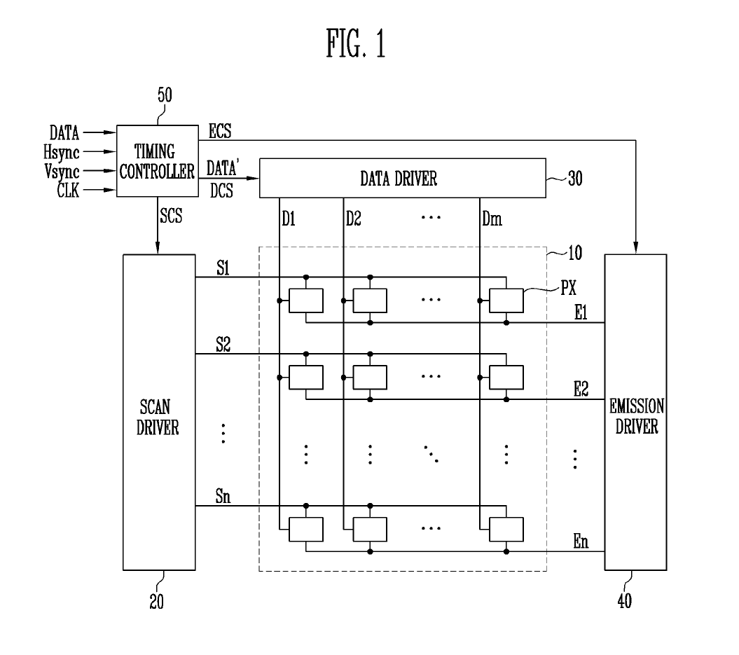

FIG. 1 is a schematic block diagram of an organic light emitting display device according to an embodiment.

Referring to FIG. 1, the organic light emitting display device may include a pixel unit 10, a scan driver 20, a data driver 30, an emission driver 40, and a timing controller 50.

The pixel unit 10 includes a plurality of pixels PX connected to scan lines S1 to Sn, data lines D1 to Dm, and emission control lines E1 to En and arranged in a matrix. The pixels PX receive scan signals through the scan lines S1 to Sn, receive data signals through the data lines D1 to Dm, and receive emission control signals through the emission control lines E1 to En. The pixels PX emit light components with brightness components corresponding to the data signals supplied from the data lines D1 to Dm when the scan signals are supplied from the scan lines S1 to Sn.

The scan driver 20 is connected to the plurality of scan lines S1 to Sn, generates the scan signals in response to a scan driving control signal SCS of the timing controller 50, and outputs the generated scan signals to the scan lines S1 to Sn. The scan driver 20 may be formed of a plurality of stage circuits. When the scan signals are sequentially supplied to the scan lines S1 to Sn, the pixels PX are selected in units of horizontal lines.

The data driver 30 is connected to the plurality of data lines D1 to Dm, generates the data signals based on a data driving control signal DCS and image data DATA′ of the timing controller 50, and outputs the generated data signals to the data lines D1 to Dm. The data signals supplied to the data lines D1 to Dm are supplied to the pixels PX selected by the scan signals whenever the scan signals are supplied. Then, the pixels PX may charge voltages corresponding to the data signals.

The emission driver 40 is connected to the plurality of emission control lines E1 to En, generates the emission control signals in response to an emission driving control signal ECS of the timing controller 50, and outputs the generated emission control signals to the emission control lines E1 to En. The emission driver 40 may be formed of a plurality of stage circuits, supplies the emission control signals to the emission control lines E1 to En, and controls emission periods of the pixels PX.

The timing controller 50 receives synchronizing signals Hsync and Vsync and a clock signal CLK for controlling image data DATA and display of the image data DATA. The timing controller 50 processes the input image data DATA, generates the image data DATA′ corrected to be suitable for displaying an image of the pixel unit 10, and outputs the generated image data DATA′ to the data driver 30. In addition, the timing controller 50 may generate the driving control signals SCS, DCS, and ECS for controlling driving of the scan driver 20, the data driver 30, and the emission driver 40 based on the synchronizing signals Hsync and Vsync and the clock signal CLK. Specifically, the timing controller 50 generates the scan driving control signal SCS and supplies the generated scan driving control signal SCS to the scan driver 20, generates the data driving control signal DCS and supplies the generated data driving control signal DCS to the data driver 30, and generates the emission driving control signal ECS and supplies the generated emission driving control signal ECS to the emission driver 40.

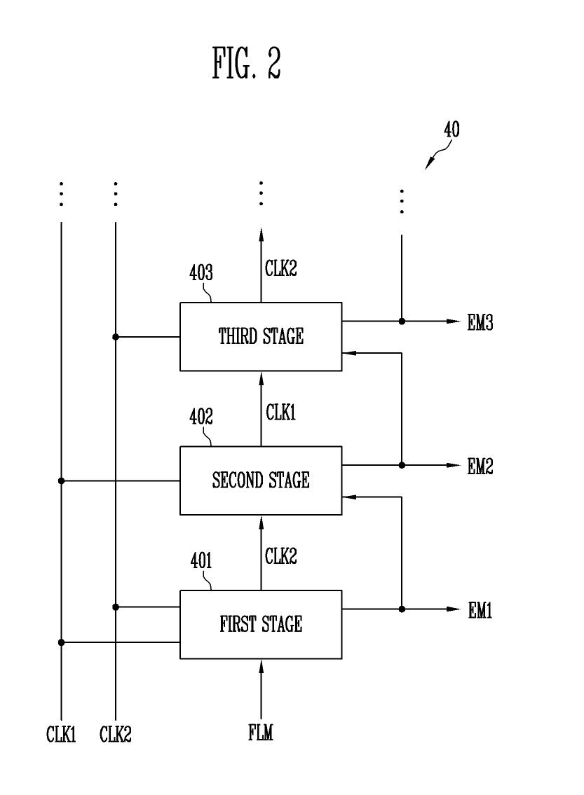

FIG. 2 is a schematic block diagram of the emission driver 40 of the organic light emitting display device illustrated in FIG. 1.

Referring to FIG. 2, the emission driver 40 includes a plurality of stages 401, 402, 403, etc. in order to supply the emission control signals to the emission control lines E1 to En. The three stages 401, 402, and 403 are illustrated, and the other stages may have structures analogous to structures related to the stages 401, 402, and/or 403. The stages 401, 402, and 403 are driven by a start signal FLM and first and second clock signals CLK1 and CLK2 and respectively output emission control signals EM1, EM2, and EM3. The emission driving control signal ECS from the timing controller 50 may include the start signal FLM and the first and second clock signals CLK1 and CLK2.

The first stage 401 among the stages 401, 402, and 403 receives the start signal FLM and the stages 402 and 403 excluding the first stage 401 respectively receive the emission control signals EM1 and EM2 of previous stages. In addition, the first stage 401 directly receives the first and second clock signals CLK1 and CLK2 and each of the stages 402 and 403 excluding the first stage 401 receives one of the first and second clock signals CLK1 and CLK2 from a previous stage. Specifically, the third stage 403 that is an odd stage excluding the first stage 401 receives the first clock signal CLK1 from the previous stage and directly receives the second clock signal CLK2. Each of the second and fourth stages 402 and 404 that are even stages directly receives the first clock signal CLK1 and receives the second clock signal CLK2 from a previous stage.

The first stage 401 outputs the first emission control signal EM1 in response to the start signal FLM and the first and second clock signals CLK1 and CLK2 and transmits the second clock signal CLK2 and the first emission control signal EM1 to the second stage 402. The second stage 402 outputs the second emission control signal EM2 in response to the directly input first clock signal CLK1 and the second clock signal CLK2 and the first emission control signal EM1 that are received from the first stage 401 and transmits the first clock signal CLK1 and the second emission control signal EM2 to the third stage 403. The third stage 403 outputs the third emission control signal EM3 in response to the directly input second clock signal CLK2 and the first clock signal CLK1 and the second emission control signal EM2 that are received from the second stage 402 and transmits the second clock signal CLK2 and the third emission control signal EM3 to the fourth stage (not shown).

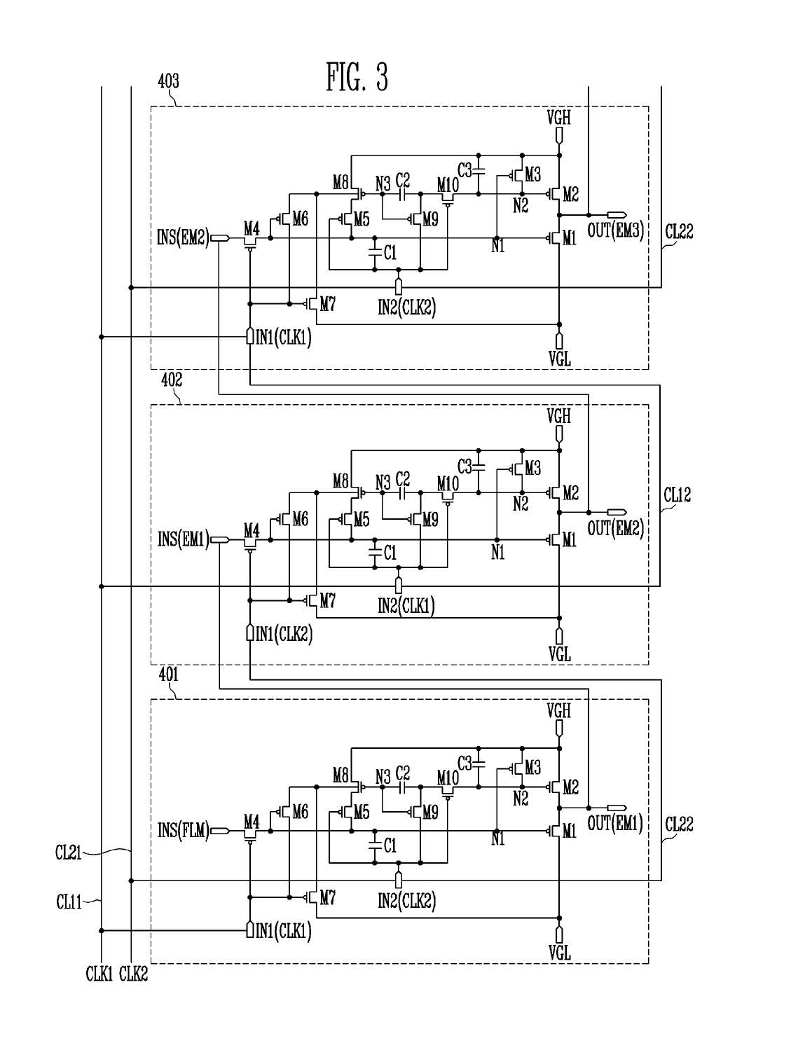

FIG. 3 is a circuit diagram of the stages of the emission driver 40 illustrated in FIG. 2.

Referring to FIG. 3, each of the stages 401, 402, and 403 includes first to tenth transistors M1 to M10 and first to third capacitors C1 to C3. A first main clock signal line CL11, first-type branch clock signal lines (which are directly connected to the first main clock signal line CL11), and first sub-clock signal lines CL12 (or first-type interconnect clock signal lines CL12) transmit the first clock signal CLK1. A second main clock signal line CL21, second-type branch clock signal lines (which are directly connected to the second main clock signal line CL21), and second sub-clock signal lines CL22 (or second-type interconnect clock signal lines CL22) transmit the second clock signal CLK2.

The first transistor M1 is connected between an output terminal OUT that outputs an emission control signal and a first power source VGL and has a gate electrode connected to a first node N1. The first transistor M1 controls a voltage of the output terminal OUT in response to a voltage applied to the first node N1. For example, when the first transistor M1 is turned on, the low-voltage first power source VGL is supplied to the output terminal OUT and the output terminal OUT outputs a low-voltage emission control signal.

The second transistor M2 is connected between the output terminal OUT and a second power source VGH and has a gate electrode connected to a second node N2. The second transistor M2 controls the voltage of the output terminal OUT in response to a voltage applied to the second node N2. For example, when the second transistor M2 is turned on, the high-voltage second power source VGH is supplied to the output terminal OUT and the output terminal OUT outputs a high-voltage emission control signal.

The third transistor M3 is connected between the second power source VGH and the second node N2 and has a gate electrode connected to the first node N1. The third transistor M3 is turned on or off in response to the voltage applied to the first node N1 and controls the voltage of the second node N2. For example, the third transistor M3 is turned on when a low voltage is applied to the first node N1 and supplies the high-voltage second power source VGH to the second node N2. Therefore, when the low voltage is applied to the first node N1, since a high voltage is supplied to the second node N2, the first and second transistors M1 and M2 are turned on or off at different times.

The fourth transistor M4 is connected between a start terminal INS and the first node N1 and has a gate electrode connected to a first input terminal IN1 (i.e., first-type clock-input terminal IN1). The fourth transistor M4 is turned on or off in response to the first clock signal CLK1 or the second clock signal CLK2 that is supplied to the first input terminal IN1. When the fourth transistor M4 is turned on, the start terminal INS and the first node N1 are electrically connected to each other. When the fourth transistor M4 is turned on, the start signal FLM or an emission control signal of a previous stage is supplied to the first node N1 and the first transistor M1 is turned on in response to the voltage of the first node N1.

Here, start terminals INS receive the start signal FLM or the emission control signals of the previous stages. The start terminal INS of the first stage receives the start signal FLM and the start terminals INS of the stages excluding the first stage receive the emission control signals of the previous stages. For example, the start terminal INS of the first stage 401 receives the start signal FLM. The start terminal INS of the second stage 402 is connected to the output terminal OUT of the first stage 401 and receives the first emission control signal EM1. The start terminal INS of the third stage 403 is connected to the output terminal OUT of the second stage 402 and receives the second emission control signal EM2.

First input terminals IN1 (i.e., first-type clock-input terminals IN1) receive the first clock signal CLK1 or the second clock signal CLK2. Specifically, the first input terminals IN1 of the odd stages excluding the first stage are connected to the first sub-clock signal lines CL12 connected to second input terminals IN2 (i.e., second-type clock-input terminals IN2) of previous stages and receive the first clock signal CLK1 through the first sub-clock signal lines CL12. Since the first stage has no previous stage, the first input terminal IN1 of the first stage is connected to the first main clock signal line CL11 and receives the first clock signal CLK1 through the first main clock signal line CL11. The first input terminals IN1 of the even stages are connected to the second sub-clock signal lines CL22 connected to second input terminals IN2 of previous stages and receive the second clock signal CLK2 through the second sub-clock signal lines CL22.

For example, the first input terminal IN1 of the first stage 401 receives the first clock signal CLK1 through the first main clock signal line CL11. The first input terminal IN1 of the second stage 402 is connected to the second sub-clock signal line CL22 connected to the second input terminal IN2 of the first stage 401 and receives the second clock signal CLK2 through the second sub-clock signal line CL22. The first input terminal IN1 of the third stage 403 is connected to the first sub-clock signal line CL12 connected to the second input terminal IN2 of the second stage 402 and receives the first clock signal CLK1 through the first sub-clock signal line CL12.

The fifth transistor M5 is connected between the first node N1 and the eighth transistor M8 and has a gate electrode connected to a second input terminal IN2. The fifth transistor M5 is turned on or off in response to the first clock signal CLK1 or the second clock signal CLK2 that is supplied to the second input terminal IN2. For example, when the low-voltage first or second clock signal CLK1 or CLK2 is applied to the second input terminal IN2, the fifth transistor M5 is turned on.

Here, second input terminals IN2 receive the first clock signal CLK1 or the second clock signal CLK2. Specifically, the second input terminals IN2 of the odd stages are connected to the second main clock signal line CL21 and receive the second clock signal CLK2 through the second main clock signal line CL21. In addition, the second input terminals IN2 of the odd stages are connected to the second sub-clock signal lines CL22 connected to first input terminals IN1 of next stages. The second input terminals IN2 of the even stages are connected to the first main clock signal line CL11 and receive the first clock signal CLK1 through the first main clock signal line CL11. In addition, the second input terminals IN2 of the even stages are connected to the first sub-clock signal lines CL12 connected to the first input terminals IN1 of the next stages.

For example, the second input terminal IN2 of the first stage 401 receives the second clock signal CLK2 through the second main clock signal line CL21 and is connected to the second sub-clock signal line CL22 connected to the first input terminal IN1 of the second stage 402. That is, the second clock signal CLK2 supplied to the first stage 401 is transmitted to the second stage 402 through the first stage 401. The second input terminal IN2 of the second stage 402 receives the first clock signal CLK1 through the first main clock signal line CL11 and is connected to the first sub-clock signal line CL12 connected to the first input terminal IN1 of the third stage 403. That is, the first clock signal CLK1 supplied to the second stage 402 is transmitted to the third stage 403 through the second stage 402.

A first capacitor C1 is connected between the second input terminal IN2 and the first node N1. The first capacitor C1 controls the voltage of the first node N1 in response to the first clock signal CLK1 or the second clock signal CLK2 that is supplied to the second input terminal IN2.

The sixth transistor M6 is connected between the first input terminal IN1 and a third node N3 and has a gate electrode connected to the first node N1. The sixth transistor M6 is turned on or off in response to the voltage applied to the first node N1 and controls a voltage of the third node N3. For example, the sixth transistor M6 is turned on when the low voltage is applied to the first node N1 and supplies a voltage corresponding to the first clock signal CLK1 or the second clock signal CLK2 that is applied to the first input terminal IN1 to the third node N3.

The seventh transistor M7 is connected between the first power source VGL and the third node N3 and has a gate electrode connected to the first input terminal IN1. The seventh transistor M7 is turned on or off in response to the first clock signal CLK1 or the second clock signal CLK2 that is supplied to the first input terminal IN1 and controls the voltage of the third node N3. For example, the seventh transistor M7 is turned on when the low-voltage first or second clock signal CLK1 or CLK2 is applied to the first input terminal IN1 and supplies the low-voltage first power source VGL to the third node N3.

The eighth transistor M8 is connected between the second power source VGH and the fifth transistor M5 and has a gate electrode connected to the third node N3. The eighth transistor M8 is turned on or off in response to the voltage applied to the third node N3 and electrically connects the second power source VGH and the fifth transistor M5 to each other or electrically insulates the second power source VGH and the fifth transistor M5 from each other.

The ninth transistor M9 is connected between the second input terminal IN2 and the tenth transistor M10 and has a gate electrode connected to the third node N3. The ninth transistor M9 is turned on or off in response to the voltage applied to the third node N3 and electrically connects the second input terminal IN2 and the tenth transistor M10 to each other or electrically insulates the second input terminal IN2 and the tenth transistor M10 from each other.

The tenth transistor M10 is connected between the ninth transistor M9 and the second node N2 and has a gate electrode connected to the second input terminal IN2. The tenth transistor M10 is turned on or off in response to the first clock signal CLK1 or the second clock signal CLK2 that is supplied to the second input terminal IN2. For example, when the low-voltage first or second clock signal CLK1 or CLK2 is applied to the second input terminal IN2, the tenth transistor M10 is turned on so that the ninth transistor M9 and the second node N2 are electrically connected to each other.

A second capacitor C2 is connected between the third node N3 and the tenth transistor M10. The second capacitor C2 is connected between the gate electrode of the ninth transistor M9 and a first electrode of the ninth transistor M9. The second capacitor C2 charges a voltage corresponding to a voltage difference between both ends and maintains the voltage difference during floating.

A third capacitor C3 is connected between the second power source VGH and the second node N2. The third capacitor C3 charges a voltage corresponding to a voltage difference between the second power source VGH and the second node N2 and maintains the voltage difference during floating.

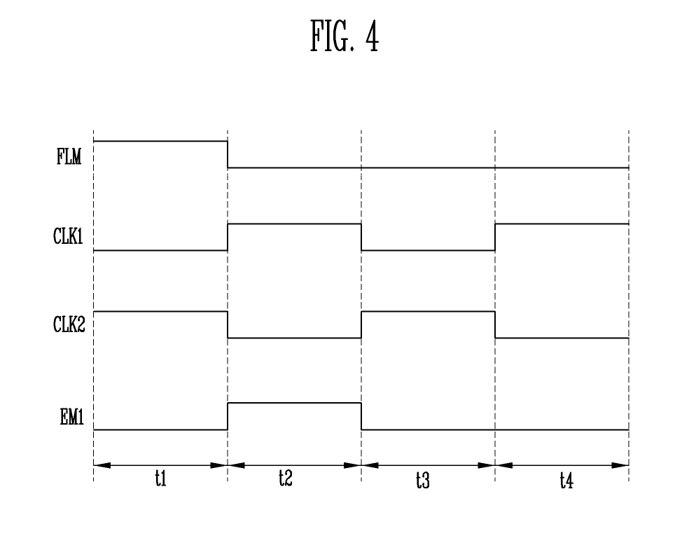

FIG. 4 is a waveform diagram illustrating an operation of the first stage of FIG 3.

Referring to FIGS. 3 and 4, the first stage 401 receives the start signal FLM by the start terminal INS, receives the first clock signal CLK1 by the first input terminal IN1, and receives the second clock signal CLK2 by the second input terminal IN2. The output terminal OUT of the first stage 401 outputs the first emission control signal EM1. Here, a high voltage and a low voltage are alternately and repeatedly applied to the first clock signal CLK1 and the second clock signal CLK2.

First, in a first period t1, the start signal FLM has a high voltage, the first clock signal CLK1 has a low voltage, and the second clock signal CLK2 has a high voltage. When the first clock signal CLK1 has the low voltage, the fourth and seventh transistors M4 and M7 are turned on. Through the turned on fourth transistor M4, the high-voltage start signal FLM is supplied to the first node N1. When the first node N1 has a high voltage, the first, third, and sixth transistors M1, M3, and M6 are turned off. In addition, through the turned on seventh transistor M7, the low-voltage first power source VGL is supplied to the third node N3. When the third node N3 has a low voltage, the eighth and ninth transistors M8 and M9 are turned on.

On the other hand, when the second clock signal CLK2 has a high voltage, the fifth and tenth transistors M5 and M10 are turned off. Since the third and tenth transistors M3 and M10 that supply voltages to the second node N2 are turned off, the gate electrode of the second transistor M2 is floated and maintains a previous state. When the first transistor M1 that controls the voltage of the output terminal OUT is turned off and the previous state of the second transistor M2 is a turn-off state, the output terminal OUT is floated and maintains a previous state. According to the current embodiment, it is assumed that the previous state of the output terminal OUT is a low voltage. Therefore, in the first period t1, the first stage 401 outputs the low-voltage first emission control signal EM1.

Next, in a second period t2, the start signal FLM has a low voltage, the first clock signal CLK1 has a high voltage, and the second clock signal CLK2 has a low voltage. When the first clock signal CLK1 has the high voltage, the fourth and seventh transistors M4 and M7 are turned off Since the sixth and seventh transistors M6 and M7 that supply voltages to the third node N3 are turned off, the third node N3 is floated and maintains a low voltage that is a previous state. When the third node N3 has the low voltage, the eighth and ninth transistors M8 and M9 are turned on.

On the other hand, when the second clock signal CLK2 has the low voltage, the fifth and tenth transistors M5 and M10 are turned on. Through the turned on fifth and eighth transistors M5 and M8, the high-voltage second power source VGH is supplied to the first node N1. When the first node N1 has a high voltage, the first, third, and sixth transistors M1, M3, and M6 are turned off In addition, through the turned on ninth and tenth transistors M9 and M10, the low-voltage second clock signal CLK2 is supplied to the second node N2. When the second node N2 has a low voltage, the second transistor M2 is turned on so that the high-voltage second power source VGH is supplied to the output terminal OUT. Therefore, in the second period t2, the first stage 401 outputs the high-voltage first emission control signal EM1.

Next, in a third period t3, the start signal FLM has a low voltage, the first clock signal CLK1 has a low voltage, and the second clock signal CLK2 has a high voltage. When the first clock signal CLK1 has the low voltage, the fourth and seventh transistors M4 and M7 are turned on. Through the turned on fourth transistor M4, the low-voltage start signal FLM is supplied to the first node N1. When the first node N1 has a low voltage, the first, third, and sixth transistors M1, M3, and M6 are turned off. Through the turned on first transistor M1, the low-voltage first power source VGL is supplied to the output terminal OUT. In addition, through the turned on third transistor M3, the high-voltage second power source VGH is supplied to the second node N2. When the second node N2 has a high voltage, the second transistor M2 is turned off. Therefore, in the third period t3, the first stage 401 outputs the low-voltage first emission control signal EM1.

Next, in a fourth period t4, the start signal FLM has a low voltage, the first clock signal CLK1 has a high voltage, and the second clock signal CLK2 has a low voltage. When the first clock signal CLK1 has the high voltage, the fourth and seventh transistors M4 and M7 are turned off. The first node N1 is floated and maintains the low voltage of the third period t3 that is a previous state. When the first node N1 has a low voltage, the first, third, and sixth transistors M1, M3, and M6 are turned on. Through the turned on first transistor M1, the low-voltage first power source VGL is supplied to the output terminal OUT. In addition, through the turned on third transistor M3, the high-voltage second power source VGH is supplied to the second node N2. When the second node N2 has a high voltage, the second transistor M2 is turned off. Therefore, in the fourth period t4, the first stage 401 outputs the low-voltage first emission control signal EM1.

In an embodiment, in nth stages excluding the first stage 401, the start signal FLM may be replaced by an emission control signal of an (n−1)th stage and the first emission control signal EM1 may be replaced by an nth emission control signal.

According to embodiments, in a driver (e.g., an emission driver) for use in controlling a display device, an input terminal of a current stage is connected through a sub-clock signal line to an input terminal of a previous stage that is connected to a capacitor of the previous stage. Therefore, it is possible to prevent static electricity from being directly applied to a gate of a transistor connected to the sub-clock signal line. Advantageously, the driver may be substantially protected against static electricity, and satisfactory performance of the driver may be maintained.

Example embodiments have been disclosed. Although specific terms are employed, they are used and are to be interpreted in a generic and descriptive sense and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Various changes in form and details may be made without departing from the spirit and scope set forth in the following claims.

What is claimed is:

1. An emission driver including a plurality of stages,
wherein each of the stages comprises:
a first transistor connected between an output terminal, which is configured for outputting an emission control signal, and a first power source and having a gate electrode connected to a first node;
a second transistor connected between the output terminal and a second power source and having a gate electrode connected to a second node;
a third transistor connected between the second power source and the second node and having a gate electrode connected to the first node;
a fourth transistor connected between a start terminal, which is configured for receiving a start signal or an emission control signal of a previous stage, and the first node and having a gate electrode connected to a first input terminal; and
a first capacitor connected between a second input terminal and the first node,
wherein first input terminals of odd stages excluding a first stage are connected to first sub-clock signal lines, which are connected to second input terminals of previous stages,
wherein second input terminals of the odd stages excluding the first stage are connected to a second main clock signal line and second sub-clock signal lines,
wherein the second sub-clock signal lines are connected to first input terminals of next stages,
wherein first input terminals of even stages are connected to second sub-clock signal lines, which are connected to second input terminals of previous stages,
wherein second input terminals of the even stages are connected to a first main clock signal line and first sub-clock signal lines, and
wherein the first sub-clock signal lines are connected to first input terminals of next stages.

2. The emission driver of claim 1,
wherein the first main clock signal line and the first sub-clock signal lines transmit a first clock signal, and
wherein the second main clock signal line and the second sub-clock signal lines transmit a second clock signal.

3. The emission driver of claim 2, wherein a high voltage and a low voltage are alternately and repeatedly applied to the first clock signal and the second clock signal.

4. The emission driver of claim 3,
wherein the first sub-clock signal lines are connected to the second input terminals of the even stages and the first input terminals of the odd stages, and
wherein the second sub-clock signal lines are connected to the second input terminals of the odd stages and the first input terminals of the even stages.

5. The emission driver of claim 4,
wherein a start terminal of the first stage receives the start signal, and
wherein start terminals of stages excluding the first stage receive emission control signals of previous stages.

6. The emission driver of claim 5,
wherein a first input terminal of the first stage receives a copy of the first clock signal through the first main clock signal line,
wherein the first input terminals of the odd stages excluding the first stage receive copies of the first clock signal through the first sub-clock signal lines, and
wherein the second input terminals of the odd stages receive copies of the second clock signal through the second main clock signal lines.

7. The emission driver of claim 5,
wherein the first input terminals of the even stages receive copies of the second clock signal through the second sub-clock signal lines, and
wherein the second input terminals of the even stages receive copies of the first clock signal through the first main clock signal line.

8. The emission driver of claim 1, further comprising:
a fifth transistor connected between the first node and an eighth transistor and having a gate electrode connected to a second input terminal;
a sixth transistor connected between the first input terminal and a third node and having a gate electrode connected to the first node;
a seventh transistor connected between the first power source and the third node and having a gate electrode connected to the first input terminal;
the eighth transistor is connected between the second power source and the fifth transistor and having a gate electrode connected to the third node;
a ninth transistor connected between the second input terminal and a tenth transistor and having a gate electrode connected to the third node;
a tenth transistor connected between the ninth transistor and the second node and having a gate electrode connected to the second input terminal; and
a second capacitor connected between the tenth transistor and the third node.

9. The emission driver of claim 8, wherein the second capacitor is connected between the gate electrode of the ninth transistor and a first electrode of the ninth transistor.

10. The emission driver of claim 8, further comprising a third capacitor connected between the second power source and the second node.

11. An organic light emitting display device comprising:
a pixel unit including pixels connected to scan lines, data lines, and emission control lines;
a scan driver configured to supply scan signals to the pixels through the scan lines;
a data driver configured to supply data signals to the pixels through the data lines; and
an emission driver including a plurality of stages respectively connected to the emission control lines and configured to supply emission control signals to the pixels through the emission control lines,
wherein each of the stages comprises:
a first transistor connected between an output terminal, which is configured for outputting an emission control signal, and a first power source and having a gate electrode connected to a first node;
a second transistor connected between the output terminal and a second power source and having a gate electrode connected to a second node;
a third transistor connected between the second power source and the second node and having a gate electrode connected to the first node;
a fourth transistor connected between a start terminal, which is configured for receiving a start signal or an emission control signal of a previous stage, and the first node and having a gate electrode connected to a first input terminal; and
a first capacitor connected between a second input terminal and the first node,
wherein first input terminals of odd stages excluding a first stage are connected to first sub-clock signal lines, which are connected to second input terminals of previous stages,
wherein second input terminals of the odd stages excluding the first stage are connected to a second main clock signal line and second sub-clock signal lines,
wherein the second sub-clock signal lines are connected to first input terminals of next stages,
wherein first input terminals of even stages are connected to second sub-clock signal lines, which are connected to second input terminals of previous stages,
wherein second input terminals of the even stages are connected to a first main clock signal line and first sub-clock signal lines,
wherein the first sub-clock signal lines are connected to first input terminals of next stages.

12. A driver for use in controlling a display device, the driver comprising:
a first stage, which comprises a first clock-input terminal and a second clock-input terminal, wherein the first clock-input terminal is electrically connected to a first main clock signal line, wherein the second clock-input terminal is electrically connected to a second main clock signal line, wherein the first main clock signal line is configured to transmit a first clock signal, and wherein the second main clock signal line is configured to transmit a second clock signal;
a second stage, which comprises a third clock-input terminal and a fourth clock-input terminal, wherein the third clock-input terminal is electrically connected through the second clock-input terminal to the second main clock signal line, and wherein the fourth clock-input terminal is electrically connected to the first main clock signal line; and
a third stage, which comprises a fifth clock-input terminal and a sixth clock-input terminal, wherein the fifth clock-input terminal is electrically connected through the fourth clock-input terminal to the first main clock signal line, and wherein the sixth clock-input terminal is electrically connected to the second main clock signal line.

13. The driver of claim 12 comprising: a first interconnect clock signal line, wherein a first end of the first interconnect clock signal line is electrically connected, through no transistor, to the fourth clock-input terminal, and wherein a second end of the first interconnect clock signal line is electrically connected, not through any transistor, to the fifth clock-input terminal.

14. The driver of claim 13 comprising: a capacitor, which is electrically connected through the fourth clock-input terminal to the first interconnect clock signal line.

15. The driver of claim 13 comprising: a first branch clock signal line, wherein a first end of the first branch clock signal line is electrically connected to the first main clock signal line, wherein a second end of the first branch clock signal line is electrically connected to the fourth clock-input terminal, and wherein the first branch clock signal line is electrically connected through the fourth clock-input terminal to the first interconnect clock signal line.

16. The driver of claim 15 comprising: a second branch clock signal line, wherein a first end of the second branch clock signal line is electrically connected to the first main clock signal line, wherein a second end of the second branch clock signal line is electrically connected to the fifth clock-input terminal, and wherein the second branch clock signal line is electrically connected through the fifth clock-input terminal to the first interconnect clock signal line.

17. The driver of claim 13 comprising: a branch clock signal line, wherein a first end of the branch clock signal line is electrically connected to the first main clock signal line, wherein a second end of the branch clock signal line is electrically connected to the fifth clock-input terminal, and wherein the branch clock signal line is electrically connected through the fifth clock-input terminal to the first interconnect clock signal line.

18. The driver of claim 13 comprising: a second interconnect clock signal line, wherein a first end of the second interconnect clock signal line is electrically connected, through no transistor, to the second clock-input terminal, and wherein a second end of the second interconnect clock signal line is electrically connected, not through any transistor, to the third clock-input terminal.

19. The driver of claim 18 comprising: a capacitor, which is electrically connected through the second clock-input terminal to the second interconnect clock signal line.

20. The driver of claim 18 comprising: a branch clock signal line, wherein a first end of the branch clock signal line is electrically connected to the second main clock signal line, wherein a second end of the branch clock signal line is directly connected to the second clock-input terminal, and wherein the branch clock signal line is electrically connected through the second clock-input terminal to the second interconnect clock signal line.
